(19) United States
(12) Patent Application Publication
(10) Pub. No.: US 2005/0230877 A1
(43) Pub. Date: Oct. 20, 2005

(54) Polyester containers

(75) Inventors: Robert Readdy, Hopatcong, NJ (US); Daniel J. Durham, Toledo, OH (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 11/154,582

(22) Filed: Jun. 16, 2005

Related U.S. Application Data
(63) Continuation of application No. PCT/US03/39541, filed on Dec. 12, 2003.
(60) Provisional application No. 60/433,725, filed on Dec. 16, 2002.

(51) Int. Cl. B29C 49/08

(52) U.S. Cl. 264/219; 264/537; 264/523

(57) ABSTRACT

A polyester container, such as a polyethylene terephthalate container produced by blowmolding can be given a modified exterior surface, such as a frosted appearance, by being blowmolded in a mold that has an irregular, pitted surface, the mold being at a temperature of at least about 40° C. above the glass transition temperature of the polyester resin. At this temperature of the mold the polyester resin will flow into the irregularities of the mold and produce a frosted appearance to the exterior surface of the container. One technique to give the mold an irregular, pitted surface is to grit-blast the interior of the mold that is to have the frosted appearance. Other modifications other than a frosted appearance can be imparted to the surface of a container. These include recesses, projections and serrations.

### FIELD OF THE INVENTION

This invention relates to polyester containers that have a modified appearance on the outer surface. More particularly this invention relates to methods of producing polyethylene terephthalate containers that have a frosted appearance to their outer surface.

### BACKGROUND OF THE INVENTION

There is a continuing search for techniques to produce different surface effects on polyester blowmolded containers such as polyethylene terephthalate blowmolded containers. These containers usually will be injection stretch blowmolded which increases the strength of the containers. This is the case since the polyethylene terephthalate is biaxially oriented and strain hardened as it reaches the mold surface. This also explains why it has been difficult to modify or alter the surface of these containers in the blowmolding process. The bottle surface is not sufficiently soft when it contacts the mold surface to acquire all of the fine detail of the mold surface. A reason is that polyethylene terephthalate containers usually are injection stretch blowmolded, at a temperature of about 10° C. to about 45° C. The mold will be cooled to maintain it at about this temperature. The polyethylene terephthalate parison will be at a temperature of about 80° C. to 120° C. when it is placed in the mold to be blown to the container. At these mold temperatures the polyethylene terephthalate will strain harden and increase its tensile strength prior to contact with the mold wall. Consequently it is difficult for the polyethylene terephthalate container to replicate the detail of the mold surface during the usual blowmolding process.

### BRIEF SUMMARY OF THE INVENTION

It has been found that the exterior surface of polyester containers such as polyethylene terephthalate containers can be modified during blowmolding if the temperature of the mold is maintained above the glass transition temperature (Tg) of the polyethylene terephthalate resin. Such glass transition temperatures typically are in the range of about 60° C. to 90° C. Preferably the mold temperature is more than about 30° C. above the glass transition temperature, and most preferably more than about 40° C. above the glass transition temperature if the resin. In this way the polyethylene terephthalate can still flow when it contacts the mold wall and adopt the shape and texture of the mold wall.

In particular it has been found that the exterior surface of a polyethylene terephthalate container can be modified to have a frosted or similar appearance using a mold that has an irregular, pitted surface if the mold is maintained at a temperature greater than the glass transition point of the polyethylene terephthalate resin, and preferably at least about 30° C. above the glass transition temperature and preferably more than about 40° C. above the glass transition temperature. In this way the polyethylene terephthalate will flow into the irregular-and pitted surface of the mold and give a frosted or other modified appearance to the surface of the container.

The surface of the molds can be altered in any manner to produce an irregular and pitted surface. The technique of sandblasting produces such a modified surface to good effect. This modified surface of the mold is transferred to the bottle during blowmolding.

Other modifications can be made to the surface of a blowmolded container. These can be projections, recesses, serrations and other effects, These can be functional, aesthetic and a combination of functional and aesthetic. Using the present technique the polyethylene terephthalate will flow into millimeter to micron sized spaces in a mold surface to create different surface effects in the blowmolded container.

### DETAILED DESCRIPTION OF THE INVENTION

The invention will now be described in more detail with respect to the preferred embodiments. However modifications can be made to this invention and yet be written the present concept of modifying the surface of blowmolded containers.

It has been found that the exterior surface of blowmolded polyethylene terephthalate containers can be given unique surface effects during the blowmolding process. This can be a blowmolding or an injection stretch blowmolding. However for the exterior surface of the blowmolded container to adopt the fine surface structure of the mold, the mold temperature will have to be above the glass transition temperature of these polyethylene terephthalate resins during blowmolding. Preferably the mold temperate should be more than 30° C. above the glass transition temperature, and most preferably more than about 40° C. In this way the polyethylene terephthalate resin will be able to flow into fine millimeter to micron size recesses in the mold surface during the blowmolding process.

It has been found in a preferred embodiment that the usual transparent exterior surface of blowmolded polyethylene terephthalate containers can be converted to a frosted appearance if the mold surface is sandblasted to give it a pitted, texturized appearance. This sandblasting leaves the surface with very small irregularities and pitting. The surface is irregular. It is not smooth. However, if the mold surface is above, preferably at least about 30° C., and most preferably about 40° C. above the glass transition temperature of the resin during blowmolding of the resin during blowmolding the resin will flow into these very small (micron) irregularities to produce a surface on the container which gives a frosted appearance. This frosted appearance is caused by the light striking the container surface being diffused and reflected in a irregular manner by the micro-irregular surface of the containers surface. This effect of a frosted appearance does not occur at conventional mold temperatures which are below the glass transition temperature for polyethylene terephthalate resins. In those instances the resin will set (strain harden) before it can flow into the fine detail of the mold surface and as a result the container surface will not adopt the fine features and texture of the mold surface.

The interior surfaces of the mold that are to produce a frosted or related appearance on the surface of polyethylene terephthalate container are etched to have an irregular surface. The full interior surface of the mold can be etched, or particular surfaces when the entire container is not to have the frosted or related appearance. The etching can be by any known technique, but with grit-blasting being preferred. The grit that is used can be from about 36 grit to about 120 grit, with about a 60 to 80 grit being preferred. These grits will provide a good frosted or related appearance.

A grit of less than about 40 will put a roughened surface into the mold and consequently into the container. This will impart to the surface of the container a rough surface which will enhance gripping. Such a surface allows for the skin on a persons hand to partially enter the pits in the roughened surface with the result being a better gripping. This would be useful for containers containing oils, soaps, detergents, shower gels, shampoos and the like. A grit of more than about 120 can be used to alter the mold surface to produce a dullened effect on the surface of the container. This will not be a frosted effect, rather a dull satin sheen. The grit-blasted surface of the molds can be aluminum. However stainless steel molds will have a longer mold life. When the molds are stainless steel it is projected that the molds can be used to produce up to about 5 to 10 million bottles before the mold will have to be grit-blasted again to impart the desired surface to a container.

The mold temperatures during molding preferably will be in the range of more than about 30° C., and most preferably more than about 40° C., above the glass transition point of the resin, Assuming a glass transition temperature of about 60° C. to 90° C., the desired mold temperature will be more than about 90° C. and preferably more than about 100° C. Mold temperatures of about 110° C. to about 150° C. are very useful. However, since the bottle will have to be cooled after blowmolding, and since the time in the mold needs to be kept to a minimum for mold use efficiency, a lower mold temperature that will yield the same effect is preferred. In this process the polyethylene terephthalate preform (parison) will typically be at a temperature of about 80° C. to 120° C. when placed in the mold. In a preferred embodiment the preform temperature should be about 75% to about 125% of the mold temperature.

In addition during the blowmolding process a cooling gas, such as air, should be blown into the bottle to cool the plastic surface from the inside outward. This is a high volume of cooling air. This on some equipment is known as a balayage unit. Such internal cooling techniques and equipment are typically used in the blowmolding of heat set bottles. Heat set bottles are used where the bottle is to be filled with a hot product. In the present instance this interior cooling more rapidly sets the plastic to its final shape and retains the detail of the exterior surface. In the present situation this is the detail of the frosted appearance of the exterior surface of the bottle or some other effect on the exterior surface of the bottles.

Another factor to be considered is the blow ratio of the container. As the blow ratio increases so does the strain hardening of the container surface during blowmolding. The blow ratio should be maintained in the range of about 5 to 10 with blow ratios in the range of about 6 to 9 being quite effective. The chosen blow ratio will be affected by the surface that is to be imparted to the container surface. As the mold surface setting increases from coarse to fine, the blow ratio will decrease. A lower blow ratio will allow the container surface to better replicate the surface of the mold.

Other surface effects can be placed on polyethylene terephthalate containers other than a frosted appearance. These include recesses, projections and serrations. However, the forming of a frosted appearance is a good indication that a wide range of surface effects can be accomplished on polyethylene terephthalate containers, when mold temp is sufficiently high. That is above the glass transition temperature of the resin, preferably at 30° C., and most preferably about 40° C. above the glass transition temperature.

### EXAMPLE

A mold that is used to make a 25 ounce Ultra Palmolive dish detergent bottle was modified with one side of the mold grit-blasted with 80 grit material and the other side with 36 grit and 60 grit material.

The polyethylene terephthalate (PET) resins used were:

(a) 50/50 virgin PET and recycle PET (0.78IV)
(b) KOSA 330 PET (0.75IV)
(c) Recycle PET (0.71IV)
   The bottles were high pressure blowmolded at 38 bar at a rate of 800, 1000 and 1200 bottles/hour on a Sidel machine. The initial mold temperature was 149° C. which temperature was dropped to 121° C. in 5° C. increments. The blow ratio was 7.6.

It was found that a mold oil temperature of 121° C. (mold surface temperature 113° C.-116° C.) produced a frost surface effect of the same quality as higher temperatures. Further this was found to be about equal for bottle volumes of 800 bottles/hour, 1000 bottles/hour and 1200 bottles/hour. The 80 grit mold surface produced a less defined frosted appearance with the 60 grit surface producing the best frosted appearance. The 80 grit did produce a more satin-like surface. The 36 grit surface did not produce a frosted effect as good as the 60 grit surface, the surface being too course and not as effectively diffusing incident light to give the frosted effect. However, this grit produced a better grippable surface. The IV value of the resin did not have a significant effect on the frosted effect, with the lower IV levels giving a slightly more pronounced frosted effect.

1. A method of placing on the exterior surface of a blowmolded polyester resin container modified surface features comprising forming onto a mold inner surface a negative of such modified surface features to be replicated onto the surface of said container, heating said mold to at least a temperature above the glass transition temperature of said polyester resin, placing a heated preform into said mold, and blowmolding said perform to the shape of said mold to replicate onto the surface of said container the modified surface features of the mold.

2. A method as in claim 1 wherein the polyester resin is polyethylene terephthalate.

3. A method as in claim 2 wherein said mold is at a temperature of more than about 30° C. above the glass transition temperature of said polyester resin.

4. A method as in claim 3 wherein said mold is at a temperature of more than about 40° C. above the glass transition temperature of said polyester resin.

5. A method as in claim 2 wherein said blowmolding is by injection stretch blowmolding.

6. A method as in claim 5 wherein the blow ratio is about 5 to 10.

7. A method as in claim 6 wherein the blow ratio is about 6 to 9.

8. A method as in claim 2 wherein the heated preform is at a temperature of about 75% to 125% of that of the mold.

9. A method as in claim 1 wherein the exterior surface of the container has a frosted appearance, the frosted appearance features of said mold provided by grit blasting the mold surfaces to form onto the mold inner surface the frosted modified surface features that are to be replicated onto the surface of the container.

10. A method as in claim 9 wherein said grit is about 50 grit to about 100 grit.

11. A method as in claim 10 wherein said grit is about 60 grit to about 80 grit.

12. A method as in claim 9 wherein the exterior surface of the container has a sheen appearance, the modified surface features of said mold provided by grit blasting said mold surfaces with more than an 80 grit material.

13. A method as in claim 1 wherein one of a recess or a projection is imparted to the surface of a container by modifying the inner surface of said mold to replicate onto said container one of a recess or a projection.

14. The container produced by the method of claim 1.

15. The container produced by the method of claim 3.

16. The container produced by the method of claim 6.

17. The container produced by the method of claim 9.

18. The container produced by the method of claim 10.

19. The container produced by the method of claim 14.
